(19) United States
(12) Patent Application Publication
(10) Pub. No.: US 2016/0125204 A1
(43) Pub. Date: May 5, 2016

(54) ELECTRONIC DEVICE AND METHOD FOR UNLOCKING TOUCH SCREEN

(71) Applicant: FIH (HONG KONG) LIMITED, Kowloon (HK)

(72) Inventor: HSIN-CHIEH LIN, New Taipei (TW)

(21) Appl. No.: 14/702,913

(22) Filed: May 4, 2015

(30) Foreign Application Priority Data
Oct. 29, 2014 (TW) 103137516

(51) Int. Cl. G06F 21/84; G06F 3/041; G06F 3/0488; G09G 5/02

(52) U.S. Cl. CPC G06F 21/84; G09G 5/026; G06F 3/0412; G06F 3/0488; G09G 2358/00; G09G 2354/00; G09G 2320/0666; G09G 2360/144

(57) ABSTRACT

An unlocking method for a touch screen of an electronic device includes activating a color sensor of the electronic device when the touch screen of a locked electronic device is activated. RGB values of ambient light sensed by a color sensor are calculated, the calculated RGB values are changed into secondary RGB values, display a background of the touch screen with a color resolution defined by the calculated RGB values; and display an interface elements on the touch screen according to the secondary RGB values; wherein differences between the calculated RGB values and the secondary RGB values cause a visual contrast between the displayed background and the displayed interface elements.

### CROSS-REFERENCE TO RELATED APPLICATIONS

This application claims priority to Taiwanese Patent Application No. 103137516 filed on Oct. 29, 2014, the contents of which are incorporated by reference herein.

### FIELD

The subject matter herein generally relates to touch screen unlocking technology.

### BACKGROUND

A touch screen of an electronic device can be unlocked using a variety of unlocking mechanisms, including entering a password or a sliding touch in a specific pattern across the touch screen. However, the factory unlocking mechanisms are easy and can be remembered by other people who see a movement on the touch screen.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic device including an unlocking system.

FIG. 2 is a block diagram of one embodiment of function modules of the unlocking system in the electronic device in FIG. 1.

FIG. 3 illustrates a flowchart of one embodiment of a method for unlocking a touch screen of an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means including, but not necessarily limited to; it specifically indicates open-ended inclusion or membership in a so-described combination, group, series and the like.

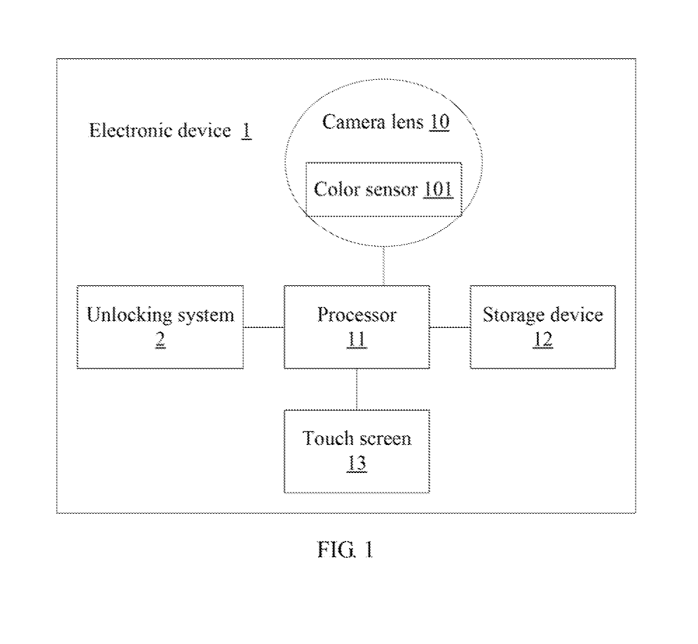

FIG. 1 illustrates a block diagram of one embodiment of an electronic device. In at least one embodiment, as shown in FIG. 1, the electronic device 1 includes, but is not limited to, a camera lens 10, at least one processor 11, a storage device 12, a touch screen 13, and an unlocking system 2. In one embodiment, the electronic device 1 can be a tablet computer, a notebook computer, a personal digital assistant device, a mobile phone, or any other electronic device. FIG. 1 illustrates only one example of the communication device 1 that can include more or fewer components than illustrated, or have a different configuration of the various components in other embodiments.

In at least one embodiment, the camera lens 10 has a color sensor 101. The color sensor 101 of the camera lens 10 can sense RGB values of ambient light. In some embodiments, the color sensor 101 can be a light to a optical current transducer, a light to a analog voltage converter, or a light to a digital voltage converter.

In at least one embodiment, the storage system 12 can include various types of non-transitory computer-readable storage medium. For example, the storage device 12 can be an internal storage system, such as a flash memory, a random access memory (RAM) for temporary storage of information, and/or a read-only memory (ROM) for permanent storage of information. The storage device 12 can also be an external storage system, such as a hard disk, a storage card, or a data storage medium. In some embodiments, the storage device 12 can store predetermined password data for unlocking the touch screen 13. The predetermined password data can be a gesture password data, a numerical password data, or a graphics password data. The at least one processor 11 can be a central processing unit (CPU), a microprocessor, or other data processor chip that performs functions of the unlocking system 2 in the electronic device 1.

In at least one embodiment, the touch screen 13 can be a touch panel, which supports multi-touch, such as resistive touch screens or capacitive touch screens.

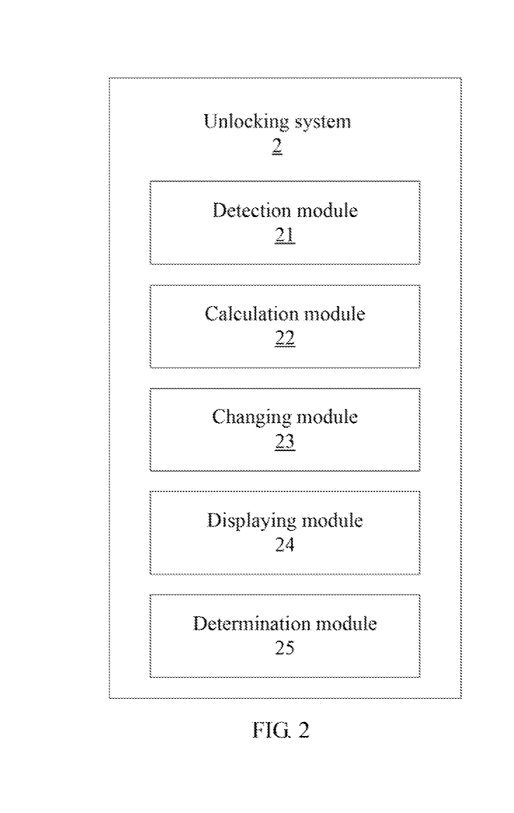

FIG. 2, is a block diagram of one embodiment of function modules of the unlocking system. In at least one embodiment, the unlocking system 2 can include a detection module 21, a calculation module 22, a changing module 23, a displaying module 24, and a determination module 25. The function modules 21-25 can include computerized code in the form of one or more programs, which are stored in the storage device 12 of the electronic device 1. The at least one processor 11 executes the computerized code to provide functions of the function modules.

The detection module 21 can detect weather the touch screen 13 is of a locked electronic device 1 is activated. When the touch screen 13 is of a locked electronic device 1 is activated (typically during an unlock procedure), the detection module 21 can activate the color sensor 101 of the camera lens 10. In some embodiments, the touch screen 13 can be activated by tapping the touch screen 13 a predetermined number of times.(e.g., two times) throughout a predetermined time duration (e.g., one second), or pushing a physical key of the electronic device 1.

The calculation module 22 can calculate red, green, blue (RGB) values of ambient light sensed by the color sensor 101.

The changing module 23 can change the calculated RGB values into secondary RGB values by increasing or decreasing a predetermined value (e.g., ten) to the calculated RGB values.

The displaying module 24 can adjust a background of the touch screen 13 with a color resolution defined by the calculated RGB values, and adjust an interface elements on the touch screen 13 according to the secondary RGB values. wherein differences between the calculated RGB values and the secondary RGB values cause a visual contrast between the displayed background and the displayed interface elements. In some embodiments, the interface elements can comprise a numeric keyboard, graphics, and unlock path.

The determination module 25 can determine whether unlock commands input by a user match with the predetermined password data for unlocking the touch screen 13 of the electronic device 1.

In at least one embodiment, the predetermined password data for unlocking the touch screen 13 can be stored in the storage device 12 of the electronic device 1.

When a determination is made that the unlock commands input by the user match with the predetermined password data for unlocking the touch screen 13, the touch screen 13 of the electronic device 1 is unlocked.

When a determination is made that the unlock commands input by the user do not match with the predetermined password data for unlocking the touch screen 13, information of failing to unlock the touch screen 13 of the electronic device 1 is generated. In one embodiment, when failing to unlock the touch screen 13 of the electronic device 1, the color sensor 101 of the camera lens 10 can reacquire ambient light for performing the unlocking operations described above again.

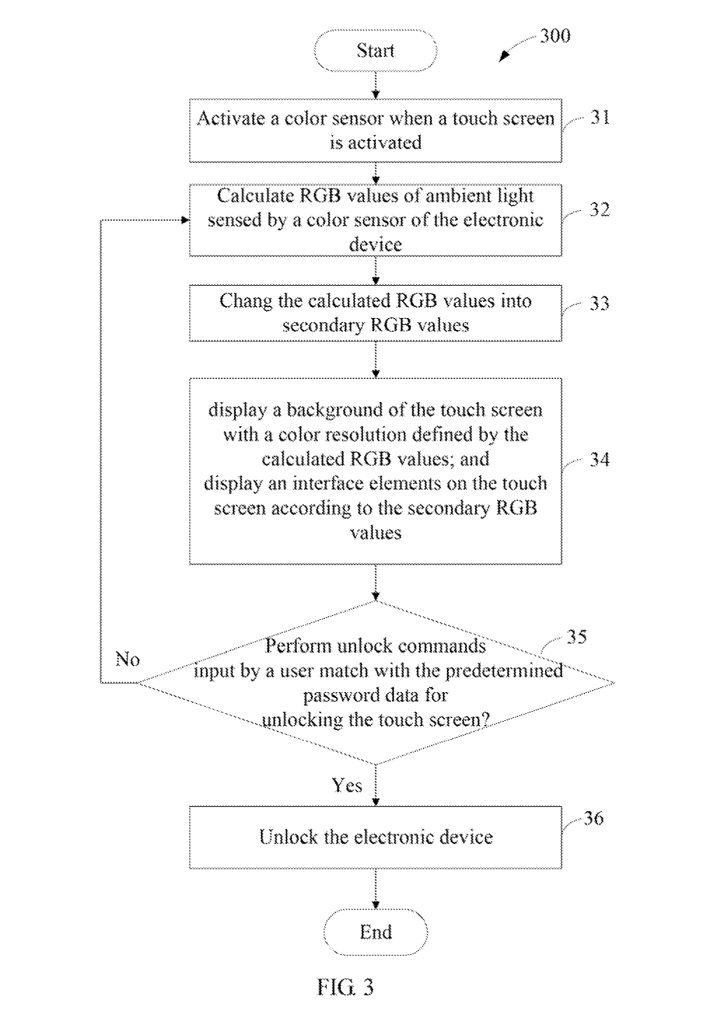

Referring to FIG. 3, a flowchart is presented in accordance with an example embodiment. The example method 300 is provided by way of example, as there are a variety of ways to carry out the method. The example method 300 described below can be carried out using the configurations illustrated in FIG. 1 and FIG. 2, for example, and various elements of these figures are referenced in explaining example method 300. Each block shown in FIG. 3 represents one or more processes, methods, or subroutines, carried out in the example method 300. Additionally, the illustrated order of blocks is by example only and the order of the blocks can be changed. The example method 300 can begin at block 31. Depending on the embodiment, additional blocks can be added, others removed, and the ordering of the blocks can be changed.

At block 31, a detection module detects weather the touch screen 13 of a locked electronic device 1 is activated, and activates a color sensor 101 of the electronic device 1 when the touch screen 13 is activated.

At block 32, a calculation module calculates RGB values of ambient light sensed by the color sensor 101.

At block 33, a change module changes the calculated RGB values into secondary RGB values by increasing or decreasing a predetermined value (e.g., ten) to the calculated RGB values.

At block 34, an displaying module adjusts a background of the touch screen 13 , and an interface elements on the touch screen 13 according to the secondary RGB values.

At block 35, a determination module determines whether unlock commands input by a user match with the predetermined password data for unlocking the touch screen 13 of the electronic device 1. If the unlock commands input by a user match the predetermined password data for unlocking the touch screen 13, procedure goes to block 36; if the unlock commands input by the user do not match the predetermined password data for unlocking the touch screen 13, procedure returns to block 32.

At block 36, the electronic device 1 is unlocked.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A method for unlocking a touch screen of an electronic device, being executed by at least one processor of the electronic device, the method comprising:
detecting, using the at least one processor, whether the touch screen of a locked electronic device is activated;
activating, in response to the detecting, a color sensor of the electronic device;
calculating RGB values of ambient light sensed by the color sensor;
changing the calculated RGB values into secondary RGB values;
displaying an unlocking screen, comprising:
displaying a background of the touch screen with a color resolution defined by the calculated RGB values; and
displaying an interface elements on the touch screen according to the secondary RGB values;
wherein differences between the calculated RGB values and the secondary RGB values cause a visual contrast between the displayed background and the displayed interface elements.

2. The method according to claim 1, further comprising:
unlocking the touch screen of the electronic device when unlock commands input by a user match with a predetermined password data for unlocking the touch screen; and
generating information of failing to unlock the touch screen of the electronic device when the unlock commands input by the user do not match with the predetermined password data for unlocking the touch screen.

3. The method according to claim 1, wherein the secondary RGB values are changed by increasing/decreasing a predetermined value to the calculated RGB values.

4. The method according to claim 3, wherein the interface elements comprise a numeric keyboard, graphics, and unlock path.

5. The method according to claim 1, wherein the color sensor of the camera lens is a light to a optical current transducer, a light to a analog voltage converter, or a light to a digital voltage converter.

6. An electronic device for unlocking a touch screen of an electronic device, the electronic device comprising:
at least one processor; and
a storage device that stores one or more programs which, when executed by the at least one processor, cause the at least one processor to:
detect, using the at least one processor, whether the touch screen of a locked electronic device is activated;
activate, in response to the detect, a color sensor of the electronic device;
calculate RGB values of ambient light sensed by the color sensor;
change the calculated RGB values into secondary RGB values;
displaying an unlocking screen, comprising:
displaying a background of the touch screen with a color resolution defined by the calculated RGB values; and
displaying an interface elements on the touch screen according to the secondary RGB values;
wherein differences between the calculated RGB values and the secondary RGB values cause a visual contrast between the displayed background and the displayed interface elements.

7. The electronic device according to claim 6, further comprising:
unlock the touch screen of the electronic device when unlock commands input by a user match with a predetermined password data for unlocking the touch screen; and
generate information of failing to unlock the touch screen of the electronic device when the unlock commands input by the user do not match with the predetermined password data for unlocking the touch screen.

8. The electronic device according to claim 6, wherein the secondary RGB values are changed by increase/decrease a predetermined value to the calculated RGB values.

9. The electronic device according to claim 8, wherein the interface elements comprise a numeric keyboard, graphics, and unlock path.

10. The electronic device according to claim 6, wherein the color sensor of the camera lens is a light to a optical current transducer, a light to a analog voltage converter, or a light to a digital voltage converter.

11. A non-transitory storage medium having stored thereon instructions that, when executed by a processor of an electronic device, causes the processor to perform a method for unlocking a touch screen of the electronic device, wherein the method comprises:
detecting, using the at least one processor, whether the touch screen of a locked electronic device is activated;
activating, in response to the detecting, a color sensor of the electronic device;
calculating RGB values of ambient light sensed by the color sensor;
changing the calculated RGB values into secondary RGB values;
displaying an unlocking screen, comprising:
displaying a background of the touch screen with a color resolution defined by the calculated RGB values; and
displaying an interface elements on the touch screen according to the secondary RGB values;
wherein differences between the calculated RGB values and the secondary RGB values cause a visual contrast between the displayed background and the displayed interface elements.

12. The non-transitory storage medium according to claim 11, further comprising:
unlocking the touch screen of the electronic device when unlock commands input by a user match with a predetermined password data for unlocking the touch screen; and
generating information of failing to unlock the touch screen of the electronic device when the unlock commands input by the user do not match with the predetermined password data for unlocking the touch screen.

13. The non-transitory storage medium according to claim 11, wherein the secondary RGB values are changed by increasing/decreasing a predetermined value to the calculated RGB values.

14. The non-transitory storage medium according to claim 13, wherein the interface elements comprise a numeric keyboard, graphics, and unlock path.

15. The non-transitory storage medium according to claim 11, wherein the color sensor of the camera lens is a light to a optical current transducer, a light to a analog voltage converter, or a light to a digital voltage converter.
